(19) United States
(12) Patent Application Publication
(10) Pub. No.: US 2007/0174284 A1
(43) Pub. Date: Jul. 26, 2007

(54) SYSTEM AND METHOD FOR CONTROLLING ACCESS TO XML DATA

(75) Inventors: Kohji Hashimoto, Kawasaki-shi (JP); Wataru Kitagawa, Fujisawa-shi (JP); Kenji Seta, Hiratsuka-shi (JP)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, ARMONK, NY (US)

(21) Appl. No.: 11/614,805

(22) Filed: Dec. 21, 2006

(30) Foreign Application Priority Data
Jan. 25, 2006 (JP) 2006-16734

(51) Int. Cl. G06F 17/30

(52) U.S. Cl. 707/9

(57) ABSTRACT

A system and method are disclosed to efficiently arbitrate access contention on a XML data between a plurality of users. A system for controlling access to XML data, includes a management section for managing holders of exclusive access rights of corresponding partial data for each of at least one partial data included in the XML data. A delegation section changes the holder of a second exclusive access right on second partial data, which is a part of first partial data, from a first holder to a second holder in order to delegate a part of a first exclusive access right held by the first holder on the first partial data. An access control section inhibits access to the second partial data from the first holder and permits access to the second partial data from the second holder on condition that the first exclusive access right is delegated.

### CROSS-REFERENCES TO RELATED APPLICATIONS

This application claims the right of priority under the Paris Convention to Japanese Patent Application Number 2006-16734 entitled “LOCK DELEGATION TECHNIQUE FOR PARALLEL UPDATING OF PARTIAL XML DATA BY MULTIPLE USERS” and filed on Jan. 25, 2006 for Kohji Hashimoto, Wataru Kitagawa, and Kenji Seta, which is incorporated herein by reference.

### BACKGROUND OF THE INVENTION

1. Field of the Invention

The present invention relates to a system for controlling access to a database, and more particularly to a system for maintaining database integrity by arbitrating contending accesses.

2. Description of the Related Art

Conventionally, the Extensible Markup Language (XML) has been used with a view to managing various data structurally and integrally. An XML document includes data between a start-tag and an end-tag. Some XML documents may have some other start-tag and end-tag between the start-tag and the end-tag. A user can define a hierarchical relation between a plurality of data by inserting this type of nested tags in the XML document.

If an enormous quantity of data is managed by a single XML document, a plurality of users need to edit the XML document individually in parallel. For example, regarding an XML document for managing space data of a newspaper, there is a case where several different editors need to edit an advertisement and a column included in the same newspaper in parallel. In this case, it is desirable to manage data in such a way as to prevent data being edited by one editor from being overwritten by other editors. Conventionally, these editors have discussed which parts should be edited with each other before editing to achieve the above management.

Furthermore, preferably data edited by one editor has integrity with data edited by other editors. For example, it is preferable to place an advertisement related to the content of a column near the advertisement so that the advertisement matches the content of the column. Therefore, conventionally editors have had a discussion before or during work in order to determine who edits what data and how it should be edited.

In some cases, however, these discussions are time-consuming or troublesome, which leads to a reduction in working efficiency. Technologies related to resolving this problem will be described below.

First, a file system for an operating system manages files in such a way that other users cannot edit a file being edited by one user. This enables access contention between a plurality of users to be automatically arbitrated in units of a file and thereby prevents a loss of the edited content.

Furthermore, conventionally there has been suggested a technology for enabling a part of data in a document or the like to be temporarily accessible only from a specific client apparatus or from a plurality of client apparatuses according to a user's operation (Refer to Patent Document 1 below).

Still further, conventionally there has been suggested a system for supporting associated editing of an SGML document (Refer to Patent Document 2 below). This system automatically generates a document type definition (DTD) for use in checking when changing a part of a document that the change does not interfere with the integrity of the entire document. The DTD is applicable only to a part of the document to be changed. Editors then change a part of the document within a range conforming to the DTD. According to this system, it is possible to determine whether a part of the document interferes with the integrity of the entire document without integrity decision of the entire document.

[Patent Document 1] Japanese Unexamined Patent Publication (Kokai) No. 2001-318818

[Patent Document 2] Japanese Unexamined Patent Publication (Kokai) No. Hei 10-143507

The above file system, however, is capable of exclusive control for each file, but not capable of exclusive control for a part of a file. In other words, the file system can set an exclusive access right to the entire XML document, but cannot set an exclusive access right only to a part of the XML document. Although it is conceivable that an exclusive access right is set to a part of the XML document by applying the mechanism of the file system, the file system cannot maintain the integrity of the entire XML document if the exclusive access right holder freely edits a part of the XML document. To prevent this, there can be an applied technology for controlling all data related to a part of corresponding data in such a way as to be noneditable if the exclusive access right is set to a part of hierarchical data. This applied technology, however, has a problem that the noneditable range is too large and it may lead to a reduction in working efficiency.

Furthermore, although the technology in the above Patent Document 1 may be used to apply the control of causing a part of data to be accessible or nonaccessible to the XML document, users need to have a discussion, as has been conventionally done, in order to maintain the integrity of the entire XML document. In addition, according to the technology in the above Patent Document 2, the structure of the entire document can be maintained without change even in the case where only a part of the document is edited. This technology, however, is not capable of maintaining the integrity of the contents of the document. Moreover, the Patent Document 2 does not describe the setting of an exclusive access right. In other words, the users need to have a discussion in order to arbitrate access contention or to maintain the integrity even with these technologies.

### SUMMARY OF THE INVENTION

### Object of the Invention

Therefore appended claims. The dependent claims define further advantageous illustrative embodiments of the present invention.

In order to resolve the above problems, according to a first aspect of the present invention, there is provided a system for controlling access to a database, comprising: a management section for managing holders of exclusive access rights of corresponding partial data for each of at least one partial data included in the database; a delegation section for changing the holder of a second exclusive access right on second partial data, which is a part of first partial data, from a first holder to a second holder in order to delegate a part of a first exclusive access right held by the first holder on the first partial data; and an access control section for inhibiting access to the second partial data from the first holder and permitting access to it from the second holder on condition that the first exclusive access right is delegated. According to other aspects of the present invention, there are provided a program for causing an information processor to operate as the system and a method of controlling the access by using the system.

The above description of the present invention does not enumerate all of the required features of the present invention and sub-combinations of these features may also be within the scope of the present invention.

According to the present invention, access contention to a database between a plurality of users can be arbitrated more efficiently than before.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an architecture of an information processing system in accordance with the present invention;

FIG. 2 is a diagram illustrating an example of an XML document stored in an XML document DB;

FIG. 3 is a schematic block diagram illustrating the logical structure of the XML document of FIG. 2 stored in the XML document DB;

FIG. 4 is a schematic block diagram illustrating one embodiment of a data structure suitable for an exclusive access right DB in accordance with the present invention;

FIG. 5 is a schematic block diagram illustrating one embodiment of an access controller in accordance with the present invention;

FIG. 6 is a schematic flow chart diagram illustrating one embodiment of a method for acquiring and releasing an exclusive access right and includes a DB access control in accordance with the present invention;

FIG. 7 is a schematic flow chart diagram illustrating details of step S600 of one embodiment of the method for acquiring and releasing an exclusive access right of FIG. 6;

FIG. 8 is a schematic flow chart diagram illustrating details of step S610 of one embodiment of the method for acquiring and releasing an exclusive access right of FIG. 6;

FIG. 9 is a schematic flow chart diagram illustrating details of step S620 of one embodiment of the method for acquiring and releasing an exclusive access right of FIG. 6;

FIG. 10 is a schematic flow chart diagram illustrating details of step S630 of one embodiment of the method for acquiring and releasing an exclusive access right of FIG. 6;

FIG. 11 is a schematic flow chart diagram illustrating one embodiment of a method for acquiring and releasing an exclusive access right that includes delegating an exclusive access right to a plurality of users sequentially in accordance with the present invention;

FIG. 12 is a schematic flow chart diagram illustrating alternative details of step S620 of one embodiment of the method for acquiring and releasing an exclusive access right of FIG. 6;

FIG. 13 is a schematic flow chart diagram illustrating one embodiment of a method for acquiring and releasing an exclusive access right in which the return of one exclusive access right delegated from the other exclusive access right is preceded by the return of the other exclusive access right in accordance with the present invention;

FIG. 14 is a schematic flow chart diagram illustrating one embodiment of a method for acquiring and releasing an exclusive access right in which one exclusive access right is delegated to a plurality of users sequentially in accordance with the present invention; and

FIG. 15 is a schematic block diagram illustrating one embodiment of system for acquiring and releasing an exclusive access right to portions of an XML document including one suitable a hardware configuration of an information processor 500 operating as the access controller in accordance with the present invention.

### DETAILED DESCRIPTION OF THE INVENTION

While the present invention will be described below by way of a preferred embodiment, the preferred embodiment described below is not intended to limit the claimed invention and all of combinations of the features described in the preferred embodiment are not necessarily essential to the present invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

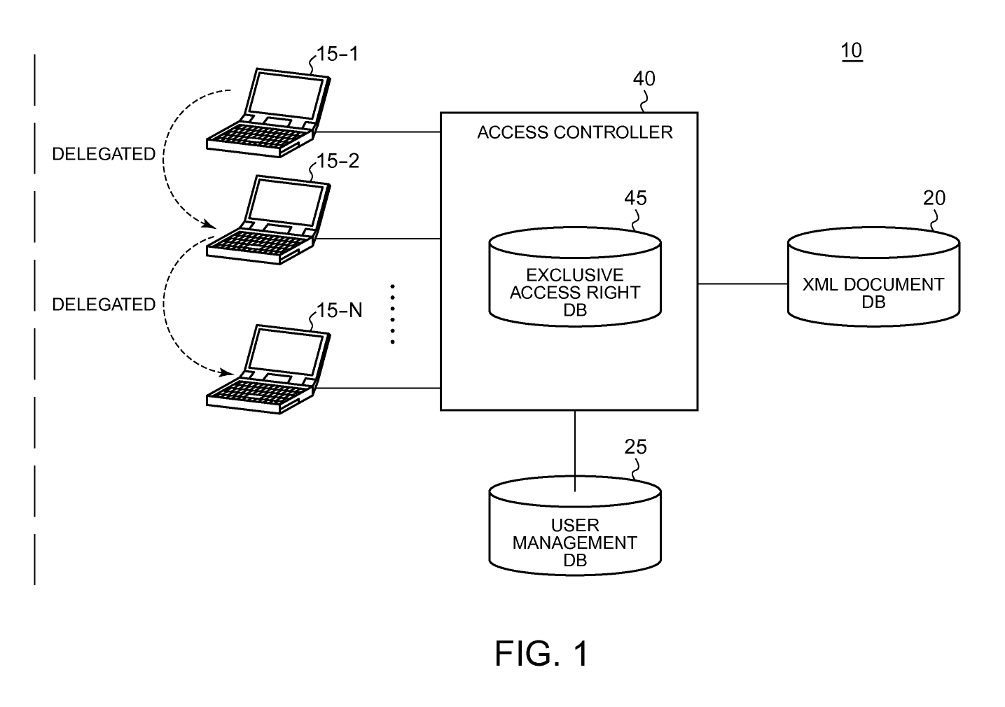

Referring to FIG. 1, there is shown an entire configuration of an information processing system 10 according to this embodiment. The information processing system 10 includes user terminals 15-1 to 15-N, an XML document DB 20, a user management DB 25, and an access controller 40. The user terminals 15-1 to 15-N are provided in such a way as to correspond to a plurality of users, respectively, and communicate with the access controller 40 to access the XML document DB 20. More specifically, each user references and edits an XML document in the XML document DB 20 by operating one of the user terminals 15-1 to 15-N. The user management DB 25 stores information representing whether access from each user to the XML document or a part thereof is permitted.

The access controller 40 accesses the XML document DB 20 on the basis of a request from one of the user terminals 15-1 to 15-N. More specifically, the access controller 40 accepts the request from the user permitted to access on the basis of the information stored in the user management DB 25 and accesses the XML document DB 20. On the other hand, the access controller 40 rejects a request from a user inhibited to access on the basis of the information stored in the user management DB 25. Moreover, the access controller 40 has an exclusive access right DB 45. The access controller 40 sets an exclusive access right that enables an exclusive access without accepting accesses from other users to the entire XML document or a part thereof on the basis of the request from one of the user terminals 15-1 to 15-N. The information on the set exclusive access right is stored and managed in the exclusive access right DB 45.

The access controller 40 according to this embodiment can not only set or reset the exclusive access right but also delegate a part of an already set exclusive access right to another user or return the delegated exclusive access right. This provides more flexible control of the exclusive access right than before and improves an efficiency of concurrent editing of a single file by a plurality of users.

The description such that a user acquires an exclusive access right means that the access controller 40 sets an exclusive access right for the user. Furthermore, the description such that the user releases the exclusive access right means that the access controller 40 cancels the setting of the exclusive access right for the user. Hereinafter, these descriptions will be used for convenience of explanation.

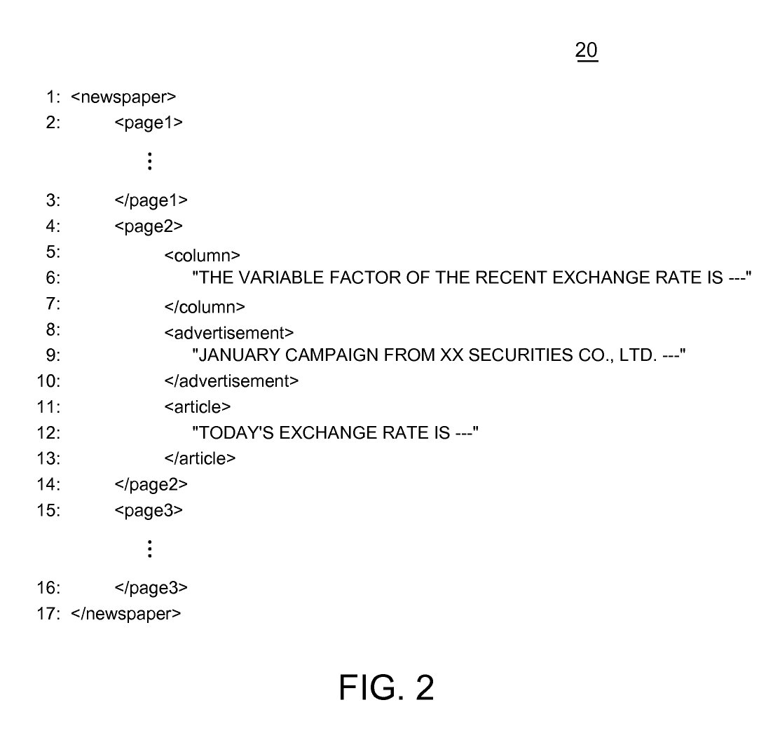

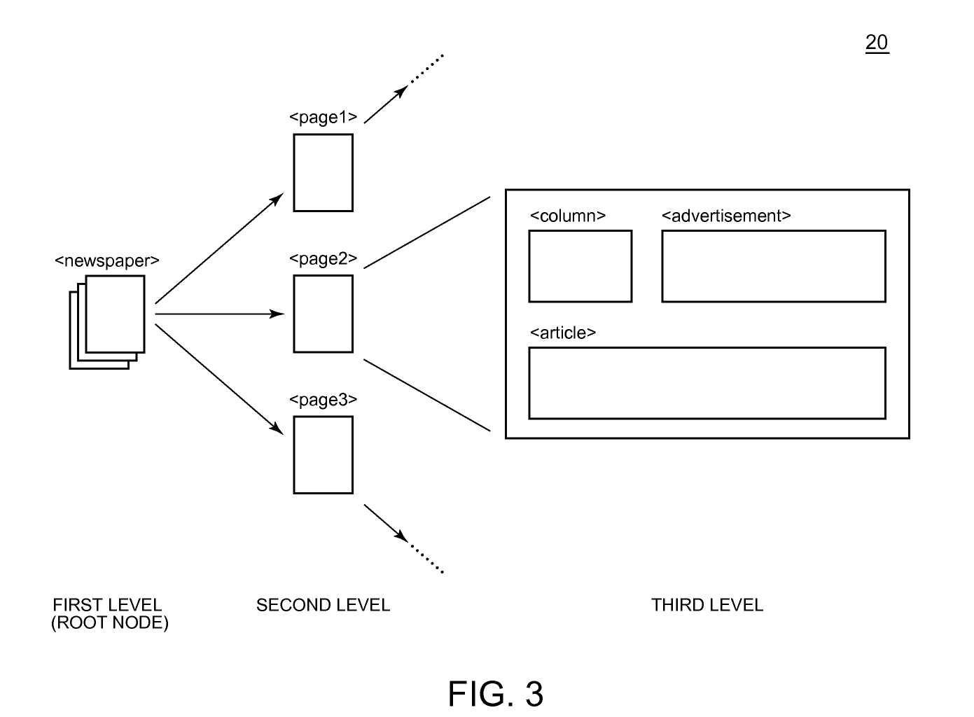

Referring to FIG. 2, there is shown an example of the XML document stored in the XML document DB 20. Referring to FIG. 3, there is shown a schematic diagram of a structure of the XML document stored in the XML document DB 20. This XML document is an example of a database according to the present invention and is described in the Extensible Markup Language (XML). The XML document includes a plurality of partial data. The XML document has a tree structure in which each of the plurality of partial data is defined as a node and a hierarchical relation between the plurality of partial data is represented as an edge.

The hierarchical relation is represented by a tag indent in FIG. 2 and its hierarchical level is represented by an arrow in FIG. 3. More specifically, a first start-tag <newspaper> and a first end-tag </newspaper> correspond to a first hierarchical level. Furthermore, a second start-tag <page2> and a second end-tag </page2> correspond to a second hierarchical level. Still further, a third start-tag <column> and a third end-tag </column> correspond to a third hierarchical level.

More specifically, first partial data described between <newspaper> and </newspaper> constitutes a first subtree and second partial data described between <page2> and </page2> constitutes a second subtree included in the first subtree. Furthermore, third partial data described between <column> and </column> constitutes a third subtree included in the second subtree. The root node of the first subtree is the tag <newspaper> and leaf nodes are tags <column>, <advertisement>, and <article>.

This XML document represents a space of newspaper, showing that the newspaper consists of three pages. In addition, the second page contains a column, an advertisement, and an article. It is assumed that the first page and the second page may be managed by different editors in some cases. Furthermore, it is assumed that the advertisement and the column may be edited by different editors in some cases. The purpose of the access controller 40 is to perform an exclusive control in order to maintain the integrity of the entire space and to prevent edited contents of other editors from being overwritten.

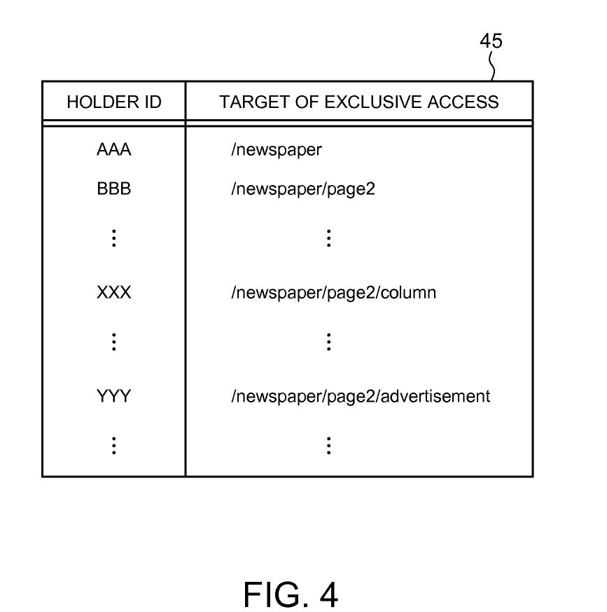

Referring to FIG. 4, there is shown an example of a data structure of the exclusive access right DB 45. The exclusive access right DB 45 stores exclusive access rights set to an XML document with the exclusive access rights associated with their holders. The target of an exclusive access is stored as identification information from the root node of the XML document to the root node of each subtree. More specifically, the identification information of the root node is path information “/newspaper” and represents a subtree having the root node <newspaper>. In other words, the path information represents the first partial data described between the start-tag <newspaper> and the end-tag </newspaper>.

The exclusive access right DB 45 stores the identification information of the holders with the identification information associated with the path information. The identification information of the holders may be login IDs used by the holders to log in to the access controller 40 or may be e-mail addresses of the holders.

If the first holder of the exclusive access right to the first subtree differs from the second holder of the exclusive access right to the second subtree included in the first subtree in FIG. 4, the exclusive access right to the second subtree is managed with being assumed to be held by the second holder. In other words, if access to certain data is requested, the access controller 40 searches the exclusive access right DB 45 for the holder of the smallest subtree (or whose root node is in the lowest hierarchical level) including the data and permits only access from the holder.

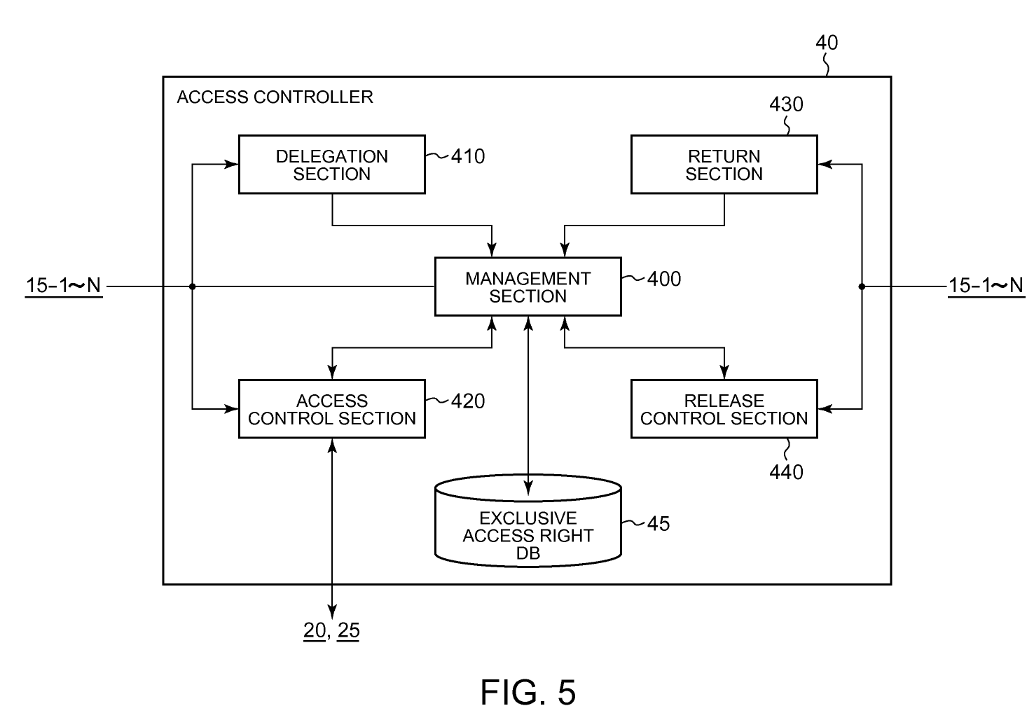

Referring to FIG. 5, there is shown a functional configuration of the access controller 40. The access controller 40 includes a management section 400, a delegation section 410, an access control section 420, a return section 430, and a release control section 440 besides the above exclusive access right DB 45. The management section 400 manages holders of exclusive access rights of partial data for each of at least one partial data included in the XML document DB 20. The partial data corresponds to a subtree in the sample database managed in the hierarchical structure and corresponds to data described between a start-tag and an end-tag in the sample XML document. As described above, the management section 400 may present the root node of the subtree as path information and manage the holder of the exclusive access right on the corresponding subtree with the holder associated with the path information. Furthermore, the management section 400 may set the exclusive access right in response to a request from one of the user terminals 15-1 to 15-N and store the content of the setting into the exclusive access right DB 45.

The delegation section 410 delegates a part of a first exclusive access right held by the first holder on the first partial data in response to the request from one of the user terminals 15-1 to 15-N. More specifically, the delegation section 410 changes the holder of a second exclusive access right on the second partial data, which is a part of the first partial data, from the first holder to the second holder. In the example shown in FIG. 4, the first holder is AAA and the first partial data corresponds to data described between the <newspaper> tag and the </newspaper> tag. In this example, the delegation section 410 delegates a part of the first exclusive access right by setting the second exclusive access right for the second holder BBB on /newspaper/page2, which is the second partial data.

The access control section 420 inhibits access from the first holder to the second partial data and permits access from the second holder thereto on condition of delegation of the first exclusive access right. More specifically, the access control section 420 inhibits access to the subtree /newspaper/page2 from the first holder AAA on condition that the exclusive access right has been set to /newspaper/page2. In response to the request from one of the user terminals 15-1 to 15-N, the return section 430 changes the holder of the second exclusive access right from the second holder to the first holder in order to return the second exclusive access right to the first holder. In the example shown in FIG. 4, the return section 430 may change the holder of the exclusive access right to the subtree /newspaper/page2 from BBB to AAA. Alternatively, the return section 430 may change the holder of the exclusive access right by deleting the exclusive access right on the subtree /newspaper/page2.

In response to a request from one of the user terminals 15-1 to 15-N, the release control section 440 releases an exclusive access right by deleting the entry of the exclusive access right from the exclusive access right DB 45. If a part of the first exclusive access right has been delegated to another holder as the second exclusive access right, the release control section 440 permits the release of the first exclusive access right on condition that the second exclusive access right is returned.

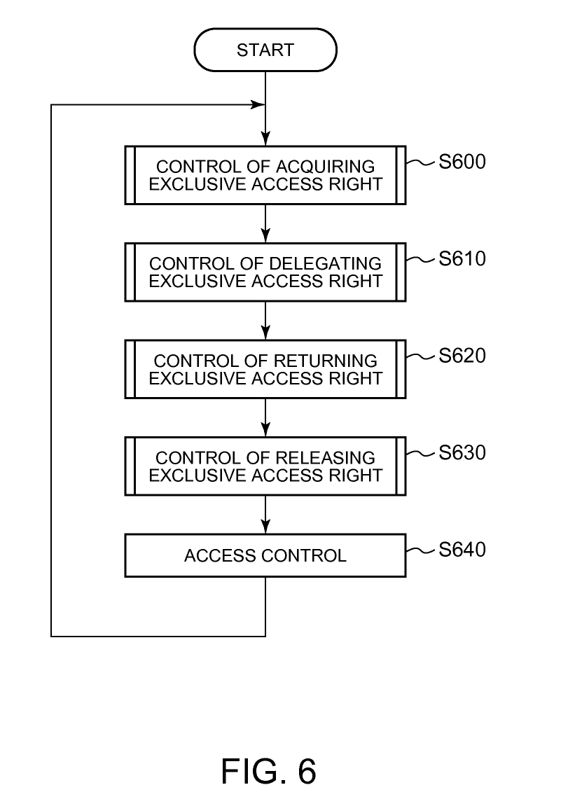

Referring to FIG. 6, there is shown a flowchart of acquiring and releasing the exclusive access right and controlling access to the database. The access controller 40, for example, repeats processing described below regularly. First, the access controller 40 performs control on acquiring the exclusive access right (S600). Subsequently, the access controller 40 performs control on delegation of the exclusive access right (S610). Then, the access controller 40 performs control on returning the delegated exclusive access right (S620). Thereafter, the access controller 40 performs control on releasing the exclusive access right (S630).

Subsequently, the access control section 420 determines whether to permit access to the XML document DB 20 from a user on the basis of the acquired exclusive access right (S640). More specifically, in response to the data access request, the access control section 420 traces back and scans the tree structure based on the data to detect the root node managed by the management section 400 and permits access from the holder corresponding to the first detected root node. Taking the exclusive access right DB 45 for example, the access control section 420 detects /newspaper/page2/column, /newspaper/page2, and /newspaper as root nodes of the subtrees by tracing back and scanning the tree structure from the column in response to the access request to the column. Then, the access control section 420 permits access from XXX corresponding to the first detected /newspaper/page2/column among them and denies access from other holders such as BBB. Herewith, where the second exclusive access right is delegated, the access control section 420 can inhibit access from the first holder and permit access from the second holder as to data included in the second subtree even if it is in the fist subtree. Furthermore, where a third exclusive access right is delegated, the access control section 420 can inhibit access from the second holder to the second subtree and permit access from the third holder.

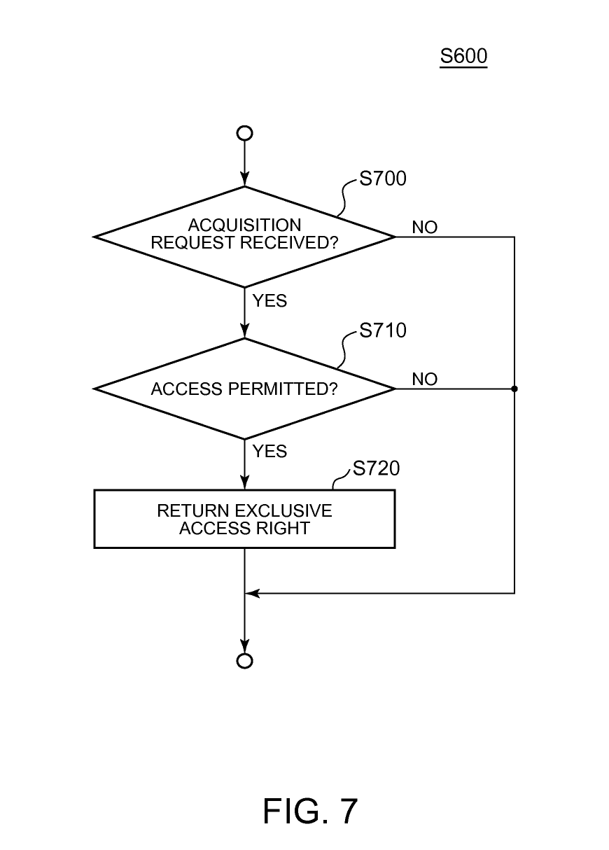

Referring to FIG. 7, there is shown details of the process in S600. The management section 400 determines whether a request for acquiring an exclusive access right is received from one of the user terminals 15-1 to 15-N (S700). Upon receiving the request (S700: YES), the management section 400 determines whether access is permitted from the requesting user to partial data (assumed to be the first partial data) as a target of the request with reference to the user management DB 25 (S710). On condition that the access is permitted (S710: YES), the management section 400 allows the user to acquire the exclusive access right (S720). More specifically, the management section 400 sets the first exclusive access right on the first partial data anew and registers the holder (assumed to be the first holder) into the exclusive access right DB 45.

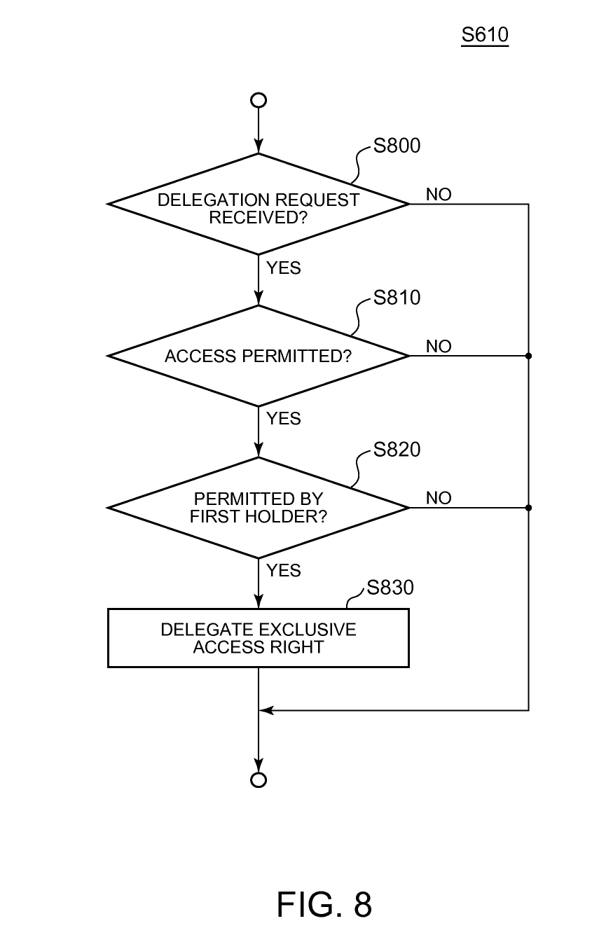

Referring to FIG. 8, there are shown details of the process in S610. The delegation section 410 determines whether a request for delegating an exclusive access right (for example, the first exclusive access right) is received from one of the user terminals 15-1 to 15-N (S800). The request for the delegation can be issued by a user who gives the exclusive access right by the delegation (for example, the first holder) or can be issued from a user who is provided with the exclusive access right by the delegation (assumed to be the second holder). Upon receiving the request (S800: YES), the delegation section 410 determines whether the second holder is permitted to access partial data (assumed to be the second partial data) to be the target of the request (S810). The delegation section 410 determines whether the access controller 40 has received an input of the first holder's permission for the delegation (S820).

The delegation section 410 delegates the exclusive access right (S830) on condition that the second holder is permitted to access the second partial data (S810: YES) and that the access controller 40 has received an input of the first holder's permission (S820: YES). More specifically, the delegation section 410 selects the second subtree, which is the second partial data, out of the plurality of subtrees included in the first subtree, which is the first partial data. The delegation section 410 then changes the holder of the second exclusive access right on the second partial subtree from the first holder to the second holder. As processing of changing the holder, for example, the delegation section 410 can cause the management section 400 to manage the identification information on the root node of the second subtree with the identification information associated with the second holder and to record it into the exclusive access right DB 45.

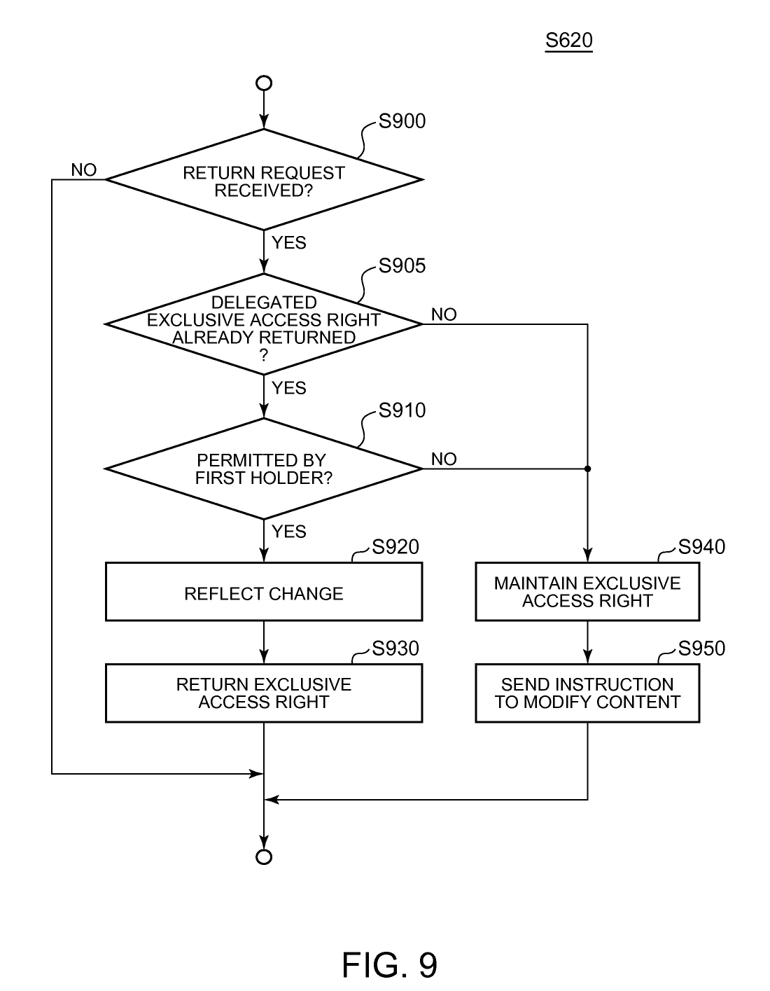

Referring to FIG. 9, there are shown details of the process in S620. The return section 430 determines whether the access controller 40 receives a request for returning the exclusive access right (for example, the second exclusive access right) from one of the user terminals 15-1 to 15-N (S900). The return request can be issued by a user who gives the exclusive access right by the return (for example, the second holder) or can be issued by a user who is provided with the exclusive access right by the return (for example, the first holder). Upon receiving the request (S900: YES), the return section 430 determines whether the exclusive access right (assumed to be the third exclusive access right) further delegated from the second exclusive access right has been completely returned with reference to the exclusive access right DB 45, for example (S905).

The return section 430 determines whether the access controller 40 has received an input of permission of the delegator (or the first holder) of the exclusive access right (S910) on condition that the third exclusive access right has already been returned (S905: YES). The return section 430 reflects the change of the second partial data caused by the second holder in the first partial data (S920) on condition that the first holder permits the return (S910: YES). Thereafter, the return section 430 changes the holder of the second exclusive access right from the second holder to the first holder (S930).

In S910, whose permission is required for the return is determined, for example, by referring to the exclusive access right DB 45. For example, the return section 430 searches the exclusive access right DB 45 for the exclusive access right to be returned, first. Subsequently, the return section 430 searches the exclusive access right DB 45 for the smallest partial data including the partial data (a subtree in the example shown in FIG. 4), which is a target of the retrieved exclusive access right. If the exclusive access right on the partial data specified by /newspaper/page2 is to be returned in the example shown in FIG. 4, partial data (for example, partial data specified by /newspaper) including the above partial data is retrieved. The return section 430 then determines the holder of the exclusive access right set to the retrieved partial data to be a holder who determines whether the return should be permitted. In other words, the return section 430 determines whether the access controller 40 has received an input of permission of this holder in S910.

On the other hand, if the third exclusive access right has not been returned yet (S905: NO) or the first holder does not permit the return (S910: NO), the return section 430 does not change the holder of the second exclusive access right (S940). More specifically, the return section 430 maintains the second exclusive access right as it is held by the second holder without reflecting the change of the second partial data caused by the second holder in the first partial data. In this case, the return section 430 can send an instruction to the second holder to modify the second partial data so that the second partial data matches the first partial data (S950).

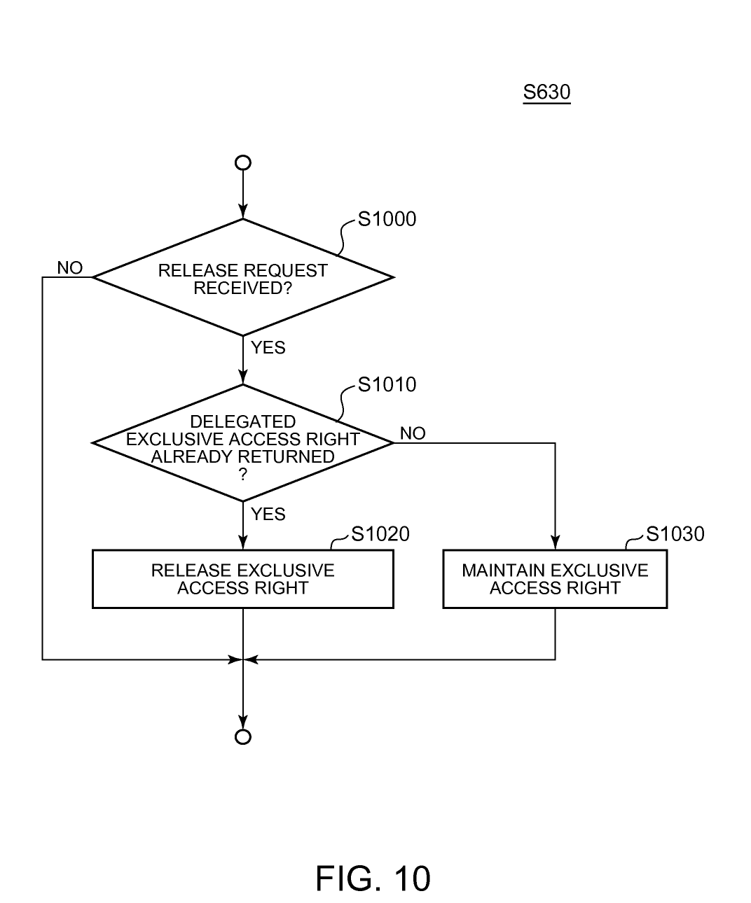

Referring to FIG. 10, there are shown details of the process in S630. The release control section 440 determines whether the access controller 40 receives a request for releasing the exclusive access right (for example, the first exclusive access right) from one of the user terminals 15-1 to 15-N (S1000). Upon receiving the request for releasing (S1000: YES), the release control section 440 determines whether the exclusive access right (for example, the second exclusive access right) delegated from the first exclusive access right has been completely returned (S1010). The release control section 440 permits the release of the first exclusive access right (S1020) on condition that the second exclusive access right has already been returned (S1010: YES). On the other hand, if the second exclusive access right has not been returned yet (S1010: NO), the release control section 440 maintains the first exclusive access right without releasing it (S1030).

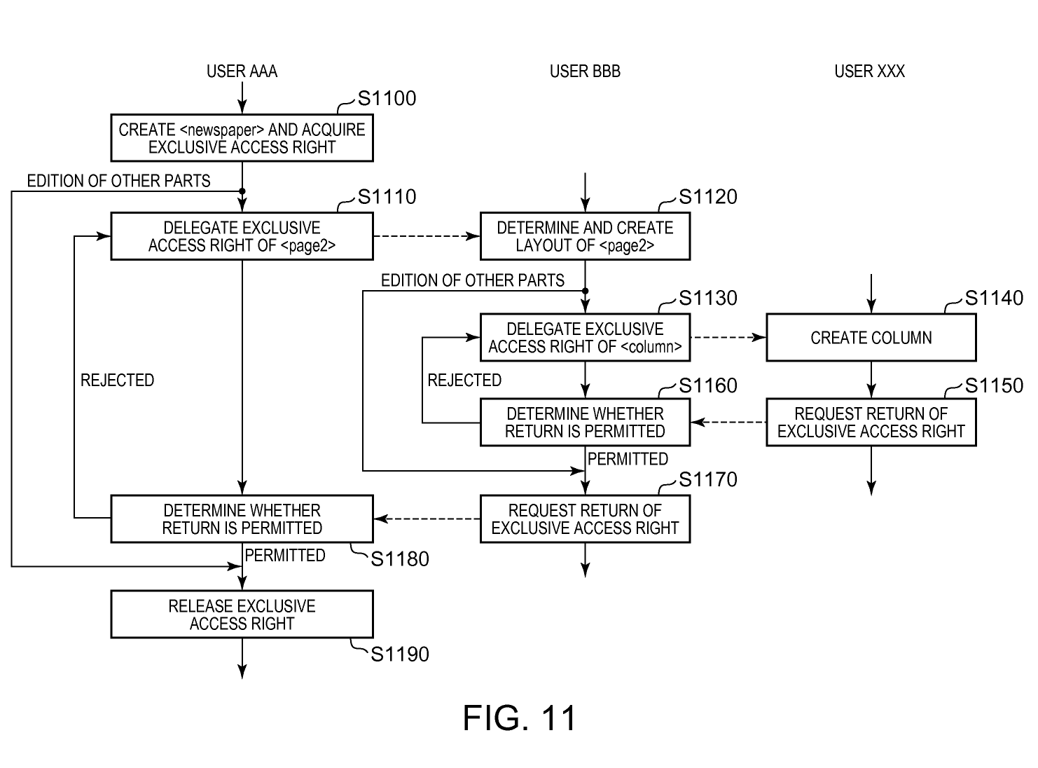

Referring to FIG. 11, there is shown the flow of processing in which a certain exclusive access right is delegated to a plurality of users sequentially. FIG. 11 shows the flow of processing with an instruction from the first user AAA, processing with an instruction from the second user BBB, and processing with an instruction from the third user XXX, starting from the left. The user AAA is, for example, a person who edits and manages the entire space of the newspaper. The user BBB is a person who edits and manages the second page of the newspaper. The user XXX is a person who edits and manages the column of the second page.

In accordance with the operation of the user AAA, the management section 400 creates a first start-tag <newspaper> and a first end-tag </newspaper> in the XML document and allows the user AAA to acquire the first exclusive access right on the first partial data described between these tags (S1100). Subsequently, the delegation section 410 creates a second start-tag <page2> and a second end-tag </page2> between <newspaper> and </newspaper> and delegates the second exclusive access right on the second partial data described between these tags to the user BBB (S1110). Alongside this operation, the access controller 40 can edit other parts excluding the part between <page2> and </page2> among the partial data described between <newspaper> and </newspaper> on the basis of the instruction from the user AAA.

The access controller 40 creates and edits (S1120) the second partial data described between <page2> and </page2> on the basis of the instruction from the user BBB on condition that the second exclusive access right is delegated (S1110). More specifically, for example, the user BBB can determine the layout of the second page of the newspaper or create a text on the second page. Subsequently, the delegation section 410 creates the third start-tag <column> and the third end-tag </column> between <page2> and </page2>. Thereafter, the delegation section 410 changes the holder of the third exclusive access right on the third partial data included in the second partial data from the user BBB to the user XXX in order to delegate the third exclusive access right on the third partial data described between these tags to the user XXX (S1130). This delegation processing is performed on condition of permission of the user BBB. Alongside this delegation processing, the access controller 40 can edit the part other than the column on the second page in accordance with the instruction from the user BBB.

The access controller 40 creates and edits the content of the column on the basis of the instruction from the user XXX (S1140). Subsequently, the access controller 40 receives a request for returning the third exclusive access right from the user XXX (S1150). The return section 430 changes the holder of the third exclusive access right from the user XXX to the user BBB with the change of the third partial data caused by the holder XXX reflected in the second partial data, on condition that the user BBB permits the return (S1160: Permitted). On the other hand, the return section 430 maintains the third exclusive access right without the change of the third partial data caused by the user XXX reflected in the second partial data, on condition that the user BBB rejects the return (S1160: Rejected). In other words, the processing returns to the state where the third exclusive access right is delegated (the state immediately after the process in S1130).

If the third exclusive access right is returned, the access controller 40 subsequently receives a request for returning the second exclusive access right from the user BBB (S1170). The return section 430 changes the holder of the second exclusive access right from the user BBB to the user AAA on condition that the third exclusive access right is returned and that the user AAA permits the return (S1180: Permitted). The return section 430 maintains the second exclusive access right without the change of the second partial data caused by the user BBB in the first partial data, on condition that the user AAA rejects the return (S1180: Rejected). More specifically, the processing returns to the state where the second exclusive access right is delegated (the state where immediately after S1110). The release control section 440 permits the release of the first exclusive access right on condition that the third exclusive access right and the second exclusive access right have been sequentially returned in this order (S1190).

As described with reference from FIG. 1 to FIG. 11 hereinabove, the access controller 40 can be used to set an exclusive access right on a part of the XML document. Moreover, the exclusive access right can be delegated and the delegated exclusive access right can be returned. Thereby, the exclusive access right can be controlled more flexibly than before, which leads to improvement in efficiency of concurrent editing of a single file by a plurality of users. Furthermore, to return or release one exclusive access right, the access controller 40 requires the return of the other exclusive access right delegated from the exclusive access right as a condition. Furthermore, this return requires permission of a delegator who delegated the other exclusive access right delegated from the exclusive access right concerned. This enables the delegator to check the integrity of data when returning the exclusive access right, by which the integrity of the entire XML document can be maintained more easily.

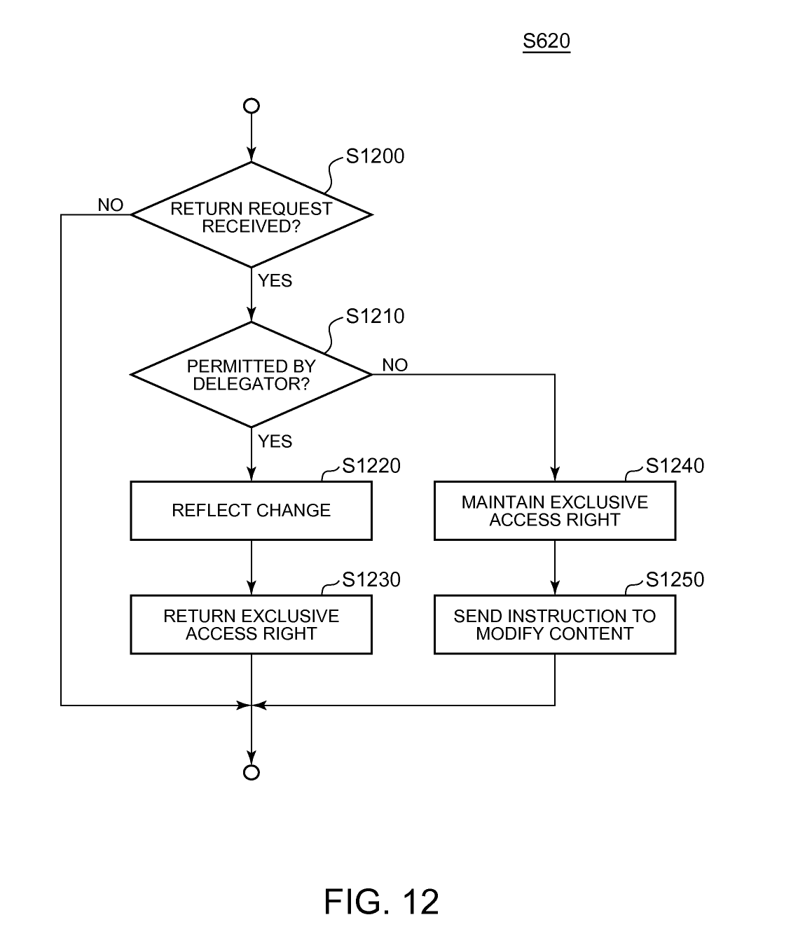

Subsequently, a variation of this embodiment will be described with reference to FIG. 12 to FIG. 14. The variation intends to depict that a more flexible control is possible on delegating an exclusive access right by relaxing the above return condition of the exclusive access right. An access controller 40 in this variation is substantially the same as the access controller 40 described with reference to FIG. 1 to FIG. 11. Therefore, the description of the access controller 40 will be omitted hereinafter except the differences.

FIG. 12 shows the details of the process in S620 according to the variation of the embodiment. The return section 430 determines whether the access controller 40 has received a request for returning an exclusive access right (for example, the second exclusive access right) from one of the user terminals 15-1 to 15-N (S1200). Upon receiving the request (S1200: YES), the return section 430 determines whether the access controller 40 has received an input of permission of the delegator (or the first holder) of the exclusive access right (S1210). In this determination, unlike the processing in FIG. 9, the return section 430 does not determine whether the exclusive access right (assumed to be the third exclusive access right) delegated further from the second exclusive access right has been completely returned. The omission of this determination relaxes the return condition of the exclusive access right in comparison with the above embodiment.

The return section 430 reflects the change of the second partial data caused by the second holder in the first partial data (S1220) on condition that the first holder permits the return (S1210: YES). Then, the return section 430 changes the holder of the second exclusive access right from the second holder to the first holder (S1230). On the other hand, unless the first holder permits the return (S1210: NO), the return section 430 does not change the holder of the second exclusive access right (S1240). In other words, the return section 430 maintains the second exclusive access right with being held by the second holder without the change of the second partial data caused by the second holder being reflected in the first partial data. In this case, the return section 430 can also send an instruction to the first holder to modify the second partial data so that the second partial data matches the first partial data (S1250).

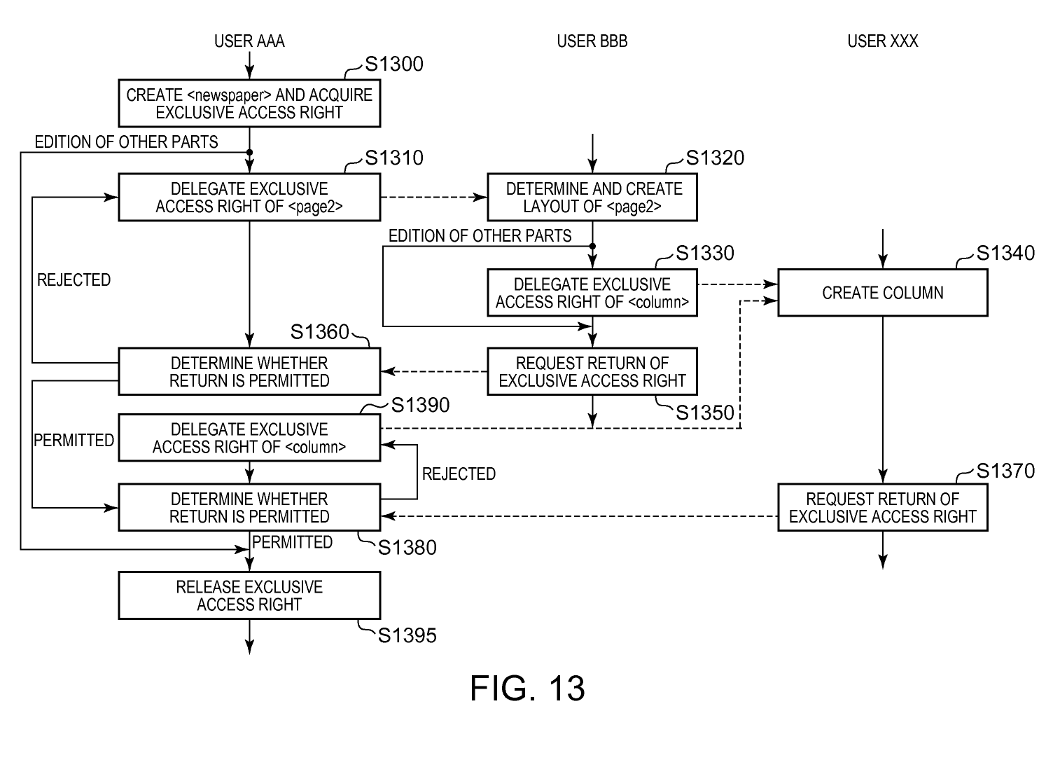

Referring to FIG. 13, there is shown the flow of processing in which the return of one exclusive access right delegated from the other exclusive access right is preceded by the return of the other exclusive access right. Similar to FIG. 11, FIG. 13 shows the flow of processing with an instruction from the first user AAA, processing with an instruction from the second user BBB, and processing with an instruction from the third user XXX, starting from the left. The user AAA is, for example, a person who edits and manages the entire space of the newspaper. The user BBB is a person who edits and manages the second page of the newspaper. The user XXX is a person who edits and manages the column of the second page.

In accordance with the operation of the user AAA, the management section 400 creates a first start-tag <newspaper> and a first end-tag </newspaper> in the XML document and allows the user AAA to acquire the first exclusive access right on the first partial data described between these tags (S1300). Subsequently, the delegation section 410 creates a second start-tag <page2> and a second end-tag </page2> between <newspaper> and </newspaper> and delegates the second exclusive access right on the second partial data described between these tags to the user BBB (S1310). Along side this operation, the access controller 40 can edit other parts excluding the part between <page2> and </page2> among the partial data described between <newspaper> and </newspaper> on the basis of the instruction from the user AAA.

The access controller 40 creates and edits the second partial data described between <page2> and </page2> on the basis of the instruction from the user BBB on condition that the second exclusive access right is delegated (S1320). More specifically, for example, the user BBB can determine the layout of the second page of the newspaper or create a text on the second page. Subsequently, the delegation section 410 creates a third start-tag <column> and a third end-tag </column> between <page2> and </page2>. Thereafter, the delegation section 410 changes the holder of the third exclusive access right on the third partial data included in the second partial data from the user BBB to the user XXX in order to delegate the third exclusive access right on the third partial data described between these tags to the user XXX (S1330). This delegation processing is performed on condition of permission of the user BBB. Alongside this delegation processing, the access controller 40 can edit the part other than the column on the second page in accordance with the instruction from the user BBB.

The access controller 40 creates and edits the content of the column on the basis of the instruction from the user XXX (S1340). On the other hand, the access controller 40 receives a request for returning the second exclusive access right from the user BBB (S1350). The return section 430 changes the holder of the second exclusive access right from the user BBB to the user AAA on condition that the user AAA permits the return (S1360: Permitted). In this manner, the second exclusive access right can be returned prior to the return of the third exclusive access right in this variation. In this state, the access control section 420 permits access from the user AAA on the part excluding the third partial data in the second partial data. On the other hand, the return section 430 maintains the second exclusive access right without the change of the second partial data caused by the user BBB reflected in the first partial data, on condition that the user AAA rejects the return (S1360: Rejected). In other words, the processing returns to the state where the second exclusive access right is delegated (the state immediately after the process in S1310).

Subsequently, the access controller 40 receives a request for returning the third exclusive access right from the user XXX (S1370). The return section 430 changes the holder of the third exclusive access right from the user XXX to the user AAA with the change of the third partial data caused by the user XXX reflected in the first partial data on condition that the user AAA permits the return (S1380: Permitted). Thus, in this variation, the first holder's permission is required to return the third exclusive access right. On the other hand, the return section 430 maintains the third exclusive access fight without the change of the third partial data caused by the user XXX reflected in the first partial data on condition that the user AAA rejects the return (S1380: Rejected). More specifically, processing returns to the state where the third exclusive access right is delegated (the state where immediately before the process in S1340).

The release control section 440 permits the release of the first exclusive access right on condition that the third exclusive access right and the second exclusive access right have been returned independently of the order (S1395).

As described hereinabove with reference to FIG. 13, the return of one exclusive access right delegated from the other exclusive access right can be preceded by the return of the other exclusive access right. In this case, the exclusive access right is returned to the user to which the other exclusive access right has been returned. Thereby, the exclusive access rights can be controlled more flexibly and the integrity of data can be maintained appropriately.

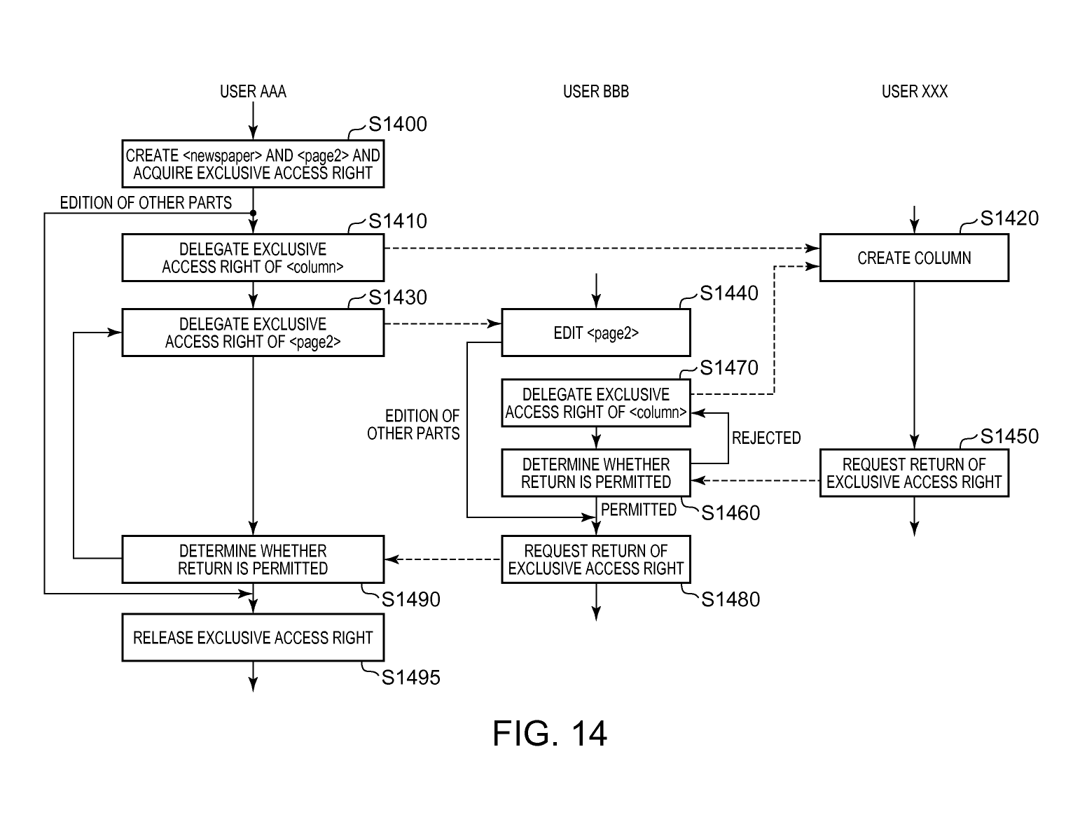

Referring to FIG. 14, there is shown the flow of processing in which one exclusive access right is delegated to a plurality of users sequentially in the variation of the embodiment. Similar to FIG. 11, FIG. 14 shows the flow of processing with an instruction from the first user AAA, processing with an instruction from the second user BBB, and processing with an instruction from the third user XXX, starting from the left. The user AAA is, for example, a person who edits and manages the entire space of the newspaper. The user BBB is a person who edits and manages the second page of the newspaper. The user XXX is a person who edits and manages the column of the second page.

In accordance with the operation of the user AAA, the management section 400 creates a first start-tag <newspaper> and a first end-tag </newspaper> in the XML document and allows the user AAA to acquire the first exclusive access right on the first partial data described between these tags (S1400). The management section 400 creates a second start-tag <page2> and a second end-tag </page2> in the XML document and allows the user AAA to acquire the second exclusive access right on the second partial data described between these tags.

Subsequently, the delegation section 410 creates a third start-tag <column> and a third end-tag </column> between <page2> and </page2> and delegates the third exclusive access right to the third partial data described between these tags to the user XXX (S1410). Alongside this operation, the access controller 40 can edit other parts excluding the part between <column> and </column> in the partial data described between <newspaper> and </newspaper> on the basis of the instruction from the user AAA. The access controller 40 creates and edits the third partial data described between <column> and </column> on the basis of the instruction from the user XXX on condition that the third exclusive access right is delegated (S1420).

In the state where the user XXX holds the third exclusive access right as described above, the access controller 40 further delegates the first exclusive access right to create an exclusive access right excluding the third exclusive access right in the second exclusive access right on the second partial data described between <page2> and </page2> and allows the user BBB to acquire the exclusive access right (S1430). The access controller 40 creates and edits data excluding the part between <column> and </column> in the second partial data on the basis of the instruction from the user BBB on condition that the exclusive access right is delegated (S1440).

Subsequently, the access controller 40 receives a request for returning the third exclusive access right from the user XXX (S1450). The return section 430 changes the holder of the third exclusive access right from the user XXX to the user BBB with the change of the third partial data caused by the user XXX reflected in the second partial data on condition that the user BBB permits the return (S1460: Permitted). On the other hand, the return section 430 maintains the third exclusive access right without the change of the third partial data caused by the user XXX in the second partial data on condition that the user BBB rejects the return (S1460: Rejected). In other words, processing returns to the state where the third exclusive access right is delegated (S1470).

If the third exclusive access right is returned, the access controller 40 subsequently receives a request for returning the second exclusive access right from the user BBB (S1480). The return section 430 changes the holder of the second exclusive access right from the user BBB to the user AAA on condition that the user AAA permits the return (S1490: Permitted). The return section 430 maintains the second exclusive access right without the change of the second partial data caused by the user BBB in the first partial data on condition that the user AAA rejects the return (S1490: Rejected). In other words, processing returns to the state where the second exclusive access right is delegated (the state immediately after the process in S1430). The release control section 440 permits the release of the first exclusive access right on condition that the third exclusive access right and the second exclusive access right have been returned independently of the order (S1495).

As described with reference to FIG. 14 hereinabove, according to the variation, a plurality of exclusive access rights can be sequentially delegated to users from a single exclusive access right, by which the exclusive access rights can be controlled more flexibly. In addition, the integrity of the partial data can also be properly determined upon return of each exclusive access right.

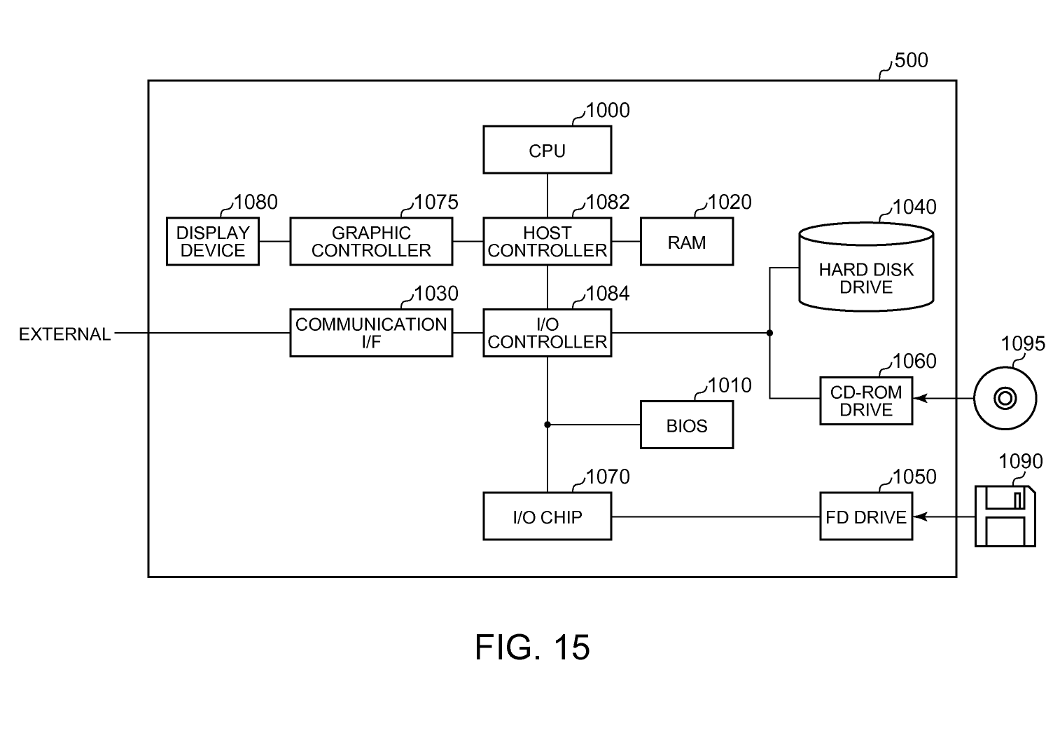

Referring to FIG. 15, there is shown an example of a hardware configuration of an information processor 500 that operates as the access controller 40 in the above embodiment or variation. The information processor 500 includes: a CPU peripheral section including a CPU 1000, a RAM 1020, and a graphic controller 1075 connected to each other via a host controller 1082; an I/O section including a communication interface 1030, a hard disk drive 1040, and a CD-ROM drive 1060 connected to the host controller 1082 via an I/O controller 1084; and a legacy I/O section including a BIOS 1010, a flexible disk drive 1050, and an I/O chip 1070 connected to the I/O controller 1084.

The host controller 1082 connects the RAM 1020 to the CPU 1000 and the graphic controller 1075, which access the RAM 1020 at high transfer rates. The CPU 1000 operates on the basis of a program stored in the BIOS 1010 and the RAM 1020 to control respective parts. The graphic controller 1075 obtains image data generated in a frame buffer provided in the RAM 1020 by the CPU 1000 or the like and displays it on a display device 1080. Alternatively, the graphic controller 1075 can contain a frame buffer for storing the image data generated by the CPU 1000 or the like inside.

The I/O controller 1084 connects the host controller 1082 to the communication interface 1030, the hard disk drive 1040, and the CD-ROM drive 1060, which are relatively fast I/O devices. The communication interface 1030 communicates with an external device on a network. The hard disk drive 1040 stores a program and data used by the information processor 500. The CD-ROM drive 1060 reads the program or data from the CD-ROM 1095 and supplies it to the RAM 1020 or the hard disk drive 1040.

Furthermore, the I/O controller 1084 is connected to the BIOS 1010, the flexible disk drive 1050, the I/O chip 1070, and the like, which are relatively slow I/O devices. The BIOS 1010 stores a boot program executed by the CPU 1000 on startup of the information processor 500, a program dependent on the hardware of the information processor 500, and the like. The flexible disk drive 1050 reads the program or data from a flexible disk 1090 and supplies it to the RAM 1020 or the hard disk drive 1040 via the I/O chip 1070. The I/O chip 1070 connects the flexible disk 1090 and various I/O devices, for example, via a parallel port, a serial port, a keyboard port, a mouse port and the like.

The program supplied to the information processor 500 is stored in a recording medium such as the flexible disk 1090, a CD-ROM 1095, or an IC card and is provided by a user. The program is read from the recording medium via the I/O chip 1070 and/or the I/O controller 1084 and installed into the information processor 500 before it is executed. The operations that the program causes the information processor 500 or the like to perform is the same as those of the access controller 40 described with reference to FIG. 1 to FIG. 14. Therefore, their description is omitted here.

The above program can also be stored in an external storage medium. The storage medium that can be used is an optical recording medium such as a DVD or a PD, a magnetooptical medium such as an MD, a tape medium, a semiconductor memory such as an IC card, or the like. In addition, it is also possible to use a storage device, as a recording medium, such as a hard disk or a RAM provided in a server system connected to a private communication network or the Internet in order to provide the program to the information processor 500 through the network.

Although the present invention has been described with reference to the preferred embodiment hereinabove, it is to be understood that the technical scope of the present invention is not limited to the above-described embodiment. It is apparent to those skilled in the art that various modifications or improvements can be made in the above embodiment. It is apparent from the appended claims that such modified or improved embodiments can also be included in the technical scope of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for controlling access to extensible markup language (XML) data,: comprising:
a management section configured to manage holders of exclusive access rights of corresponding partial data for each of at least one partial data included in the XML data;
a delegation section configured to change the holder of a second exclusive access right on a second partial data, which is a part of a first partial data, from a first holder to a second holder in order to delegate a part of a first exclusive access right held by the first holder on the first partial data; and
an access control section configured to inhibit access to the second partial data from the first holder and permit access to the second partial data from the second holder on condition that the first exclusive access right is delegated.

2. A system according to claim 1, further comprising:
a return section configured to change the holder of the second exclusive access right from the second holder to the first holder in order to return the second exclusive access right to the first holder; and
a release control section configured to permit a release of the first exclusive access right on condition that the second exclusive access right is returned.

3. A system according to claim 2, wherein:
the delegation section changes the holder of the second exclusive access right from the first holder to the second holder on condition that the first holder permits the delegation; and
wherein the return section changes the holder of the second exclusive access right from the second holder to the first holder and reflects a change of the second partial data in the first partial data on condition that the first holder permits the return, the change caused by the second holder.

4. A system according to claim 3, wherein the return section maintains the second exclusive access right held by the second holder without reflecting the change of the second partial data caused by the second holder in the first partial data in response to the first holder rejecting the return.

5. A system according to claim 3, wherein:
the delegation section changes the holder of a third exclusive access right on a third partial data nested within the second partial data from the second holder to a third holder in order to delegate a part of the second exclusive access right on condition that the second holder permits the delegation;
wherein the access control section inhibits access to the third partial data from the second holder and permits access to the third partial data from the third holder on condition that the second exclusive access right is delegated; and
wherein the return section changes the holder of the third exclusive access right from the third holder to the second holder and reflects a change of the third partial data caused by the third holder in the second partial data on condition that the second holder permits the return.

6. A system according to claim 5, wherein the return section changes the holder of the second exclusive access right from the second holder to the first holder on condition that the third exclusive access right is returned and that the first holder permits the return of the second exclusive access right.

7. A system according to claim 5, wherein:
the access control section permits access from the first holder to data in the first partial data and data in the second partial data for which the second exclusive access right is returned and inhibits access from the first holder to the third partial data on condition that the return of the third exclusive access right is preceded by the return of the second exclusive access right; and
wherein the return section returns the third exclusive access right to the first holder on condition that the first holder permits the return so long as the return of the third exclusive access right is preceded by the return of the second exclusive access right.

8. A system according to claim 7, wherein:
the delegation section further delegates a part of the first exclusive access right such that a part of the first exclusive access right is delegated to the third holder so that the third holder holds the third exclusive access right, the delegation section generates a second exclusive access right having a limitation of the third exclusive access right, and allows the second holder to acquire the limited second exclusive access right; and
wherein the return section returns the third exclusive access right to the second holder and allows the second holder to acquire the second exclusive access right with out the limitation of the third exclusive access right on condition of permission of the second holder for return of the third exclusive access right.

9. A system according to claim 1, wherein:
the XML data has a tree structure that includes nodes defined as a plurality of data and edges representing hierarchical relations determined between the plurality of data;
the first partial data is a first subtree in the tree structure and the second partial data is a second subtree nested in the first subtree;
the delegation section selects the second subtree out of the plurality of subtrees included in the first partial tree and changes the holder of the second exclusive access right on the second subtree from the first holder to the second holder; and
the access controller inhibits access from the first holder and permits access from the second holder on the data included in the second subtree even though the data in the second subtree is within the first subtree.

10. A system according to claim 9, wherein:
the management section manages holders of the exclusive access rights on the subtree with the holders associated with identification information on a root node of at least one subtree;
the delegation section changes the holder of the second exclusive access right from the first holder to the second holder by allowing the management section to manage the identification information on a root node of the second subtree with the identification information associated with the second holder; and
the access control section traces back and scans the tree structure based on a data access request for a node associated with the data access request matching a subtree root node managed by the management section and permits access from the holder corresponding to the first detected subtree root node.

11. A system according to claim 10, wherein:
the XML data is an XML document described in an Extensible Markup Language (XML);
the first subtree is data described between a first start-tag and a first end-tag corresponding to the first start-tag;
the second subtree is data described between a second start-tag and a second end-tag, which are described between the first start-tag and the first end-tag; and
the management section associates the holders with path information from a root node of the XML document to a root node of each subtree and manages the holders of the exclusive access rights of data described between a start-tag and an end-tag specified by the path information.

12. A computer program product comprising a computer readable medium having computer usable program code programmed for controlling access to eXtensible Markup Language (XML) data, the operations of the computer program product comprising:
a management section for managing holders of exclusive access rights of corresponding partial data for each of at least one partial data included in the database;
a delegation section for changing the holder of a second exclusive access right on second partial data, which is a part of first partial data, from a first holder to a second holder in order to delegate a part of a first exclusive access right held by the first holder on the first partial data; and
an access control section for inhibiting access to the second partial data from the first holder and permitting access to it from the second holder on condition that the first exclusive access right is delegated.

13. The computer program product of claim 12, wherein the first partial data is on a first hierarchical level of the XML data and the second partial data is on a second hierarchical level of the XML, the second partial data nested within the first partial data.

14. The computer program product of claim 12, wherein:
the return section changes the holder of the second exclusive access right from the second holder to the first holder in order to return the second exclusive access right to the first holder; and
the release control section permits a release of the first exclusive access right on condition that the second exclusive access right is returned.

15. The computer program product of claim 14, wherein:
the delegation section changes the holder of the second exclusive access right from the first holder to the second holder on condition that the first holder permits the delegation; and
wherein the return section changes the holder of the second exclusive access fight from the second holder to the first holder and reflects a change of the second partial data in the first partial data on condition that the first holder permits the return, the change caused by the second holder.

16. The computer program product of claim 15, wherein the return section maintains the second exclusive access right held by the second holder without reflecting the change of the second partial data caused by the second holder in the first partial data in response to the first holder rejecting the return.

17. The computer program product of claim 15, wherein:
the delegation section changes the holder of a third exclusive access right on a third partial data nested within the second partial data from the second holder to a third holder in order to delegate a part of the second exclusive access right on condition that the second holder permits the delegation;
wherein the access control section inhibits access to the third partial data from the second holder and permits access to the third partial data from the third holder on condition that the second exclusive access right is delegated; and
wherein the return section changes the holder of the third exclusive access right from the third holder to the second holder and reflects a change of the third partial data caused by the third holder in the second partial data on condition that the second holder permits the return.

18. The computer program product of claim 17, wherein the third partial data is on a third hierarchical level of the XML data, the third partial data comprising descendents of the second hierarchical level and the second partial data comprising descendents of the first hierarchical level.

19. The computer program product of claim 17, wherein the return section changes the holder of the second exclusive access right from the second holder to the first holder on condition that the third exclusive access right is returned and that the first holder permits the return of the second exclusive access right.

20. A computer implemented method for controlling access to eXtensible Markup Language (XML) data by an information processor, comprising:
managing holders of exclusive access rights of corresponding partial data for each of at least one partial data included in the database;
changing the holder of a second exclusive access right on second partial data, which is a part of first partial data, from a first holder to a second holder in order to delegate a part of a first exclusive access right held by the first holder on the first partial data; and
inhibiting access to the second partial data from the first holder and permitting access to it from the second holder on condition that the first exclusive access right is delegated.
